(19) United States
(12) Patent Application Publication
(10) Pub. No.: US 2018/0204144 A1
(43) Pub. Date: Jul. 19, 2018

(54) APPARATUS AND METHOD FOR ACCEPTING TRANSACTION RESERVATION

(71) Applicant: BOE TECHNOLOGY GROUP CO., LTD., Beijing (CN)

(72) Inventors: Haijun Su, Beijing (CN); Yue Li, Beijing (CN)

(73) Assignee: BOE TECHNOLOGY GROUP CO., LTD., Beijing (CN)

(21) Appl. No.: 15/533,214

(22) PCT Filed: Dec. 23, 2016
(86) PCT No.: PCT/CN2016/111747

§ 371 Date: Jun. 5, 2017

(30) Foreign Application Priority Data
Jun. 15, 2016 (CN) 201610424230.X

(51) Int. Cl. G06Q 10/02; G07C 11/00

(52) U.S. Cl. CPC G06Q 10/02; G07C 2011/04; G07C 11/00

(57) ABSTRACT

The present application discloses an apparatus for accepting transaction reservation, including a communication logic configured to receive from a client terminal a request for transaction reservation specifying a requested transaction type and a requested transaction time; a calculator configured to calculate a forecasted transaction time slot for the requested transaction type; and a processor configured to add the request to a queue of requests when the requested transaction time is substantially within the forecasted transaction time slot.

### CROSS-REFERENCE TO RELATED APPLICATION

This application claims priority to Chinese Patent Application No. 201610424230.X, filed Jun. 15, 2016, the contents of which are incorporated by reference in the entirety.

### TECHNICAL FIELD

The present invention relates to an apparatus and a method for accepting transaction reservation.

### BACKGROUND

Many private or public service organizations and vendors (e.g., banks, hospitals, restaurants, and amusement parks) have to deal with queuing management issues with respect to incoming customers. Accordingly, a queuing system may be adopted in these places for servicing the customers based on a queue established according to their arrival time. The queuing system typically requires a customer to stay on-site until other customers arrived earlier have been served.

### SUMMARY

In one aspect, the present invention provides an apparatus for accepting transaction reservation, comprising a communication logic configured to receive from a client terminal a request for transaction reservation specifying a requested transaction type and a requested transaction time; a calculator configured to calculate a forecasted transaction time slot for the requested transaction type; and a processor configured to add the request to a queue of requests when the requested transaction time is substantially within the forecasted transaction time slot; wherein the communication logic is configured to transmit the forecasted transaction time slot to the client terminal.

Optionally, the processor is configured to generate a reservation number based on a position of the request in the queue; and the communication logic is configured to transmit the reservation number to the client terminal.

Optionally, the calculator is configured to calculate an updated transaction time slot for the requested transaction type at a time interval after the forecasted transaction time slot is calculated; and the communication logic is configured to transmit the updated transaction time slot to the client terminal.

Optionally, the processor is configured to hold the request in a pending state when the requested transaction time is later than the forecasted transaction time slot; the communication logic is configured to transmit a signal indicating the pending state to the client terminal; the calculator is further configured to calculate an updated transaction time slot for the requested transaction type; and the processor is configured to add the request to the queue of requests when the requested transaction time is substantially within the updated transaction time slot.

Optionally, the processor is configured to place the request in a rejected state when the requested transaction time is earlier than the forecasted transaction time slot; and the communication logic is configured to transmit a signal to the client terminal indicating the request cannot be fulfilled at the requested transaction time.

Optionally, the communication logic is further configured to transmit a signal to the client terminal indicating an earliest time slot available for the requested transaction type.

Optionally, the calculator is configured to calculating the forecasted transaction time slot for the requested transaction type based on a priori information on time and a transaction processing rate.

Optionally, the calculator is configured to calculate an initial forecasted time based on the a priori information on time and the transaction processing rate; and calculate the forecasted transaction time slot based on the initial forecasted time and an adjustment factor.

Optionally, the calculator is configured to calculate a weighted average transaction duration for each type of transaction in the queue of requests in a priori time period; calculate a sum of weighted average transaction durations for a plurality of types of transactions in the queue of requests; and calculate the initial forecasted time based on a current time and the sum of weighted average transaction durations; wherein the priori time period comprises one or more a priori sub-time period; the weighted average transaction duration for each type of transaction is calculated based on a duration for completing each type of transaction in each a priori sub-time period, and a weight coefficient for the duration for completing each type of transaction in each a priori sub-time period; and the sum of weighted average transaction durations is calculated based on the weighted average transaction duration for each type of transaction, a transaction processing rate for each type of transaction, and a number of transaction requests for each type of transaction in the queue of requests.

Optionally, the calculator is configured to calculate a weighted average transaction duration t^{T} for a type T transaction in a priori time period according to Equations (1) to (3):

$$\begin{matrix}{t}^{T} = {\sum }_{i = 1}^{n} {ω}_{i}^{T} * \overline{{t}_{i}^{T}} ; & ( 1 ) \\ \overline{{t}_{i}^{T}} = \frac{{\sum }_{j = 1}^{m} {t}_{j}^{T}}{m} ; & ( 2 ) \\ {ω}_{i}^{T} = \frac{i}{{\sum }_{j = 1}^{n} j} ; & ( 3 )\end{matrix}$$

wherein the a priori time period includes n a priori sub-time periods, m numbers of type T transactions are completed in the i-th a priori sub-time period, 0<i≤n, t̅ᵢ̅^̅{̅T̅}̅ is an average duration for completing a type T transaction in the i-th a priori sub-time period, tⱼ^{T} is a duration for completing the j-th type T transaction in the i-th a priori sub-time period, 0<j≤m, ωᵢ^{T} is a weight coefficient of a duration for completing a type T transaction in the i-th a priori sub-time period;

calculate a sum t of weighted average transaction durations for p numbers of types of transactions in the queue of requests according to Equation (4):

$$t = {\sum }_{T = 1}^{p} {r}_{T} {q}_{T} {t}^{T} ; \qquad ( 4 )$$

wherein the queue of requests includes p numbers of types of transactions, the queue of requests includes q_{T} numbers of type T transaction, r_{T} is a transaction processing rate for the type T transaction, 0<r_{T}≤1; and calculate the initial forecasted time t_{z} according to Equation (5):

t_{z}=t+t₀ (5);

wherein t₀ is a current time.

Optionally, the forecasted transaction time slot is between an earliest forecasted time tₘᵢₙ; and a latest forecasted time tₘₐₓ; the calculator is configured to calculate an earliest forecasted time tₘᵢₙ according to Equation (6):

tₘᵢₙ=g₁t+t₀ (6); and

calculate a latest forecasted time tₘₐₓ according to Equation (7):

tₘₐₓ=g₂t+t₀ (7);

wherein g₁ is a first adjustment factor, g₁<1, and g₂ is a second adjustment factor, g₂>1.

In another aspect, the present invention provides a system for accepting transaction reservation, comprising an apparatus described herein; a host terminal apparatus configured to transmit real-time information regarding transaction types and transaction durations; and a client terminal apparatus configured to transmit the requested transaction type and the requested transaction time to the apparatus; and receive the forecasted transaction time slot from the apparatus.

In another aspect, the present invention provides a method for accepting transaction reservation, the method being performed by one or more processors of a server, and comprising receiving from a client terminal a request for transaction reservation specifying a requested transaction type and a requested transaction time; calculating a forecasted transaction time slot for the requested transaction type; adding the request to a queue of requests when the requested transaction time is substantially within the forecasted transaction time slot; and transmitting the forecasted transaction time slot to the client terminal.

Optionally, the method further comprises generating a reservation number based on a position of the request in the queue; and transmitting the reservation number to the client terminal.

Optionally, the method further comprises updating the forecasted transaction time slot for the requested transaction type to obtain an updated transaction time slot for the requested transaction type; and transmitting the updated transaction time slot to the client terminal.

Optionally, the method further comprises holding the request in a pending state when the requested transaction time is later than the forecasted transaction time slot; transmitting a signal indicating the pending state to the client terminal; updating the forecasted transaction time slot for the requested transaction type to obtain an updated transaction time slot for the requested transaction type; and adding the request to the queue of requests when the requested transaction time is substantially within the updated transaction time slot.

Optionally, the method further comprises placing the request in a rejected state when the requested transaction time is earlier than the forecasted transaction time slot; and transmitting a signal to the client terminal indicating the request cannot be fulfilled at the requested transaction time.

Optionally, the forecasted transaction time slot is calculated based on a priori information on time and a transaction processing rate.

Optionally, calculating a forecasted transaction time slot comprises calculating an initial forecasted time based on the a priori information on time and the transaction processing rate; and calculating the forecasted transaction time slot based on the initial forecasted time and an adjustment factor.

Optionally, calculating the initial forecasted time comprises calculating a weighted average transaction duration for each type of transaction in the queue of requests in a priori time period; calculating a sum of weighted average transaction durations for a plurality of types of transactions in the queue of requests; and calculating the initial forecasted time based on a current time and the sum of weighted average transaction durations; wherein the priori time period comprises one or more a priori sub-time period; the weighted average transaction duration for each type of transaction is calculated based on a duration for completing each type of transaction in each a priori sub-time period, and a weight coefficient for the duration for completing each type of transaction in each a priori sub-time period; and the sum of weighted average transaction durations is calculated based on the weighted average transaction duration for each type of transaction, a transaction processing rate for each type of transaction, and a number of transaction requests for each type of transaction in the queue of requests.

Optionally, calculating the initial forecasted time comprises calculating a weighted average transaction duration t^{T} for a type T transaction in a priori time period according to Equations (1) to (3):

$$\begin{matrix}{t}^{T} = {\sum }_{i = 1}^{n} {ω}_{i}^{T} * \overline{{t}_{i}^{T}} ; & ( 1 ) \\ \overline{{t}_{i}^{T}} = \frac{{\sum }_{j = 1}^{m} {t}_{j}^{T}}{m} ; & ( 2 ) \\ {ω}_{i}^{T} = \frac{i}{{\sum }_{j = 1}^{n} j} ; & ( 3 )\end{matrix}$$

wherein the a priori time period includes n a priori sub-time periods, m numbers of type T transactions are completed in the i-th a priori sub-time period, 0<i≤n, t̅ᵢ̅^̅{̅T̅}̅ is an average duration for completing a type T transaction in the i-th a priori sub-time period, tⱼ^{T} is a duration for completing the j-th type T transaction in the i-th a priori sub-time period, 0<j≤m, ωᵢ^{T} is a weight coefficient of a duration for completing a type T transaction in the i-th a priori sub-time period;

calculating a sum t of weighted average transaction durations for p numbers of types of transactions in the queue of requests according to Equation (4):

$$t = {\sum }_{T = 1}^{p} {r}_{T} {q}_{T} {t}^{T} ; \qquad ( 4 )$$

wherein the queue of requests includes p numbers of types of transactions, the queue of requests includes q_{T} numbers of type T transaction, r_{T} is a transaction processing rate for the type T transaction, 0<r_{T}≤1; and

calculating the initial forecasted time t_{z} according to Equation (5):

t_{z}=t+t₀ (5);

wherein t₀ is a current time.

Optionally, calculating the forecasted transaction time slot based on the initial forecasted time and an adjustment factor comprises calculating an earliest forecasted time tₘᵢₙ according to Equation (6):

tₘᵢₙ=g₁t+t₀ (6); and

calculating a latest forecasted time tₘₐₓ according to Equation (7):

tₘₐₓ=g₂t+t₀ (7);

wherein g₁ is a first adjustment factor, g₁<1, and g₂ is a second adjustment factor, g₂>1.

### BRIEF DESCRIPTION OF THE FIGURES

The following drawings are merely examples for illustrative purposes according to various disclosed embodiments and are not intended to limit the scope of the present invention.

FIG. 1 is a schematic block diagram of a system for performing the transaction reservation in some embodiments according to the present disclosure.

FIG. 2 is a flow chart illustrating a method for accepting transaction reservation in some embodiments according to the present disclosure.

FIG. 3 is a flow chart illustrating a method of calculating a forecasted time slot in some embodiments according to the present disclosure.

FIG. 4 is a flow chart illustrating a method of calculating a forecasted time slot in some embodiments according to the present disclosure.

FIG. 5 is a schematic block diagram of an apparatus for accepting transaction reservation in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

In one aspect, the present invention provides, inter alia, a method for accepting transaction reservation, the method being performed by one or more processors of a server. In some embodiments, the method includes receiving a request for transaction reservation specifying a requested transaction type and a requested transaction time from a client terminal; calculating a forecasted transaction time slot for the requested transaction type; adding the request to a queue of requests when the requested transaction time is substantially within the forecasted transaction time slot; and transmitting the forecasted transaction time slot to the client terminal.

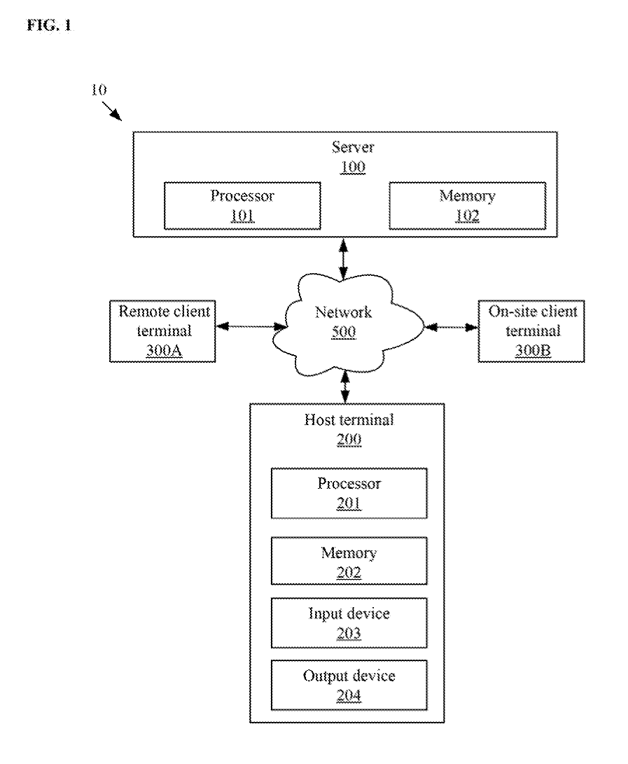

FIG. 1 is a schematic block diagram of a system for performing the transaction reservation in some embodiments according to the present disclosure. Referring to FIG. 1, the system 10 in some embodiments includes a server 100, a host terminal 200, a remote client terminal 300A and an on-site client terminal 300B.

In some embodiments, the server 100 is a computing apparatus including a processor 101 and a memory 102. Components of the server 100 are in communication with each other, either directly or indirectly. For example, the components of the server 100) may transmit and receive data or signals between each other. In another example, the components of the server 100 may be interconnected through a bus line. In some embodiments, the server 100 includes one or more processor 101 and one or more memory 102.

Referring to FIG. 1, the host terminal 200 in some embodiments includes a processor 201, a memory 202, an input device 203, and an output device 204. For example, the host terminal 200 may be a desktop computer, a notebook computer, a tablet computer, a smartphone, or other devices having a processor and a memory. In another example, the host terminal 200 may be a service server. Optionally, components of the host terminal 200 are in communication with each other, either directly or indirectly. For example, the components of the host terminal 200 may transmit and receive data or signals between each other. In another example, the components of the host terminal 200 may be interconnected through a bus line. In some embodiments, the host terminal 200 includes one or more processor 201 and one or more memory 202. In one example, the input device 203 may be a touch device, a keyboard, a microphone, a mouse, etc. The output device 204 may be a display device (e.g., a liquid crystal display panel, an organic light emitting display panel, a projector), a speaker, a vibration device, etc.

In some embodiments, the client terminal in the system 10 includes a remote client terminal 300A and an on-site client terminal 300B.

Optionally, the remote client terminal 300A includes a processor, a memory, an input device, and an output device. For example, the remote client terminal 300A may be a desktop computer, a notebook computer, a tablet computer, a smartphone, or other devices having a processor and a memory. Optionally, components of the remote client terminal 300A are in communication with each other, either directly or indirectly. For example, the components of the remote client terminal 300A may transmit and receive data or signals between each other. In another example, the components of the remote client terminal 300A may be interconnected through a bus line. In some embodiments, the remote client terminal 300A includes one or more processor and one or more memory. In one example, the input device may be a touch device, a keyboard, a microphone, a mouse, etc. The output device may be a display device (e.g., a liquid crystal display panel, an organic light emitting display panel, a projector), a speaker, a vibration device, etc.

Optionally, the on-site client terminal 300B includes a processor, a memory, an input device, and an output device. For example, the on-site client terminal 300B may be a desktop computer, a notebook computer, a tablet computer, a smartphone, or other devices having a processor and a memory. Optionally, components of the on-site client terminal 300B are in communication with each other, either directly or indirectly. For example, the components of the on-site client terminal 300B may transmit and receive data or signals between each other. In another example, the components of the on-site client terminal 300B may be interconnected through a bus line. In some embodiments, the on-site client terminal 300B includes one or more processor and one or more memory. In one example, the input device may be a touch device, a keyboard, a microphone, a mouse, etc. The output device may be a display device (e.g., a liquid crystal display panel, an organic light emitting display panel, a projector), a speaker, a vibration device, etc.

In some embodiments, a processor may process data signals and may include one or more computing architectures such as a complex instruction set computer (CISC) architecture, a reduced instruction set computer (RISC) architecture. Optionally, the processor includes a computing architecture having a combination of a plurality of instruction sets. In some embodiments, the processor is a microprocessor, such as an X86 processor, an ARM processor, or a digital processor (DSP), and the like. The processor is configured to control the other components to perform desired functions.

In some embodiments, a memory is configured to store instructions or data executed by the processor. For example, the memory may include one or more computer program products, which may include various forms of computer-readable storage media, such as volatile memory and or non-volatile memory. Examples of volatile memory include, but are not limited to, a random access memory (RAM) and a cache memory. Examples of non-volatile memory include, but are not limited to, a read-only memory (ROM), a hard disk, a flash memory. One or more computer program instructions may be stored on the computer-readable storage medium, and the processor may be configured to execute the program instructions to implement one or more desired functions. Various applications and data (e.g., data used or generated by the application program) may also be stored in the computer-readable storage medium.

Referring to FIG. 1, the system 10 in some embodiments includes a host terminal 200, a remote client terminal 300A, and an on-site client terminal 300B, each of which connected to a server 100 through a network 500. Examples of networks 500 include, but are not limited to, a wireless network, a wired network, a local area network, and a wide area network (e.g., the Internet). In another example, the network 500 includes a mobile communication access network (e.g., 4G, 3G). Optionally, the network 500 is a single network. Optionally, the network 500 includes a combination of networks.

In one example, the system 10 is a banking transaction electronic system, the host terminal is a host terminal in a bank, the remote client terminal is a user's mobile phone or a computer, and the on-site client terminal is a reservation number printing device in the bank.

In some embodiments, the system 10 further includes a virtual memory (e.g., cloud) for storing data. For example, the memory 102 of the server 100 may include or be communicatively coupled to a database in cloud (e.g., a cloud data control center) for storing data, e.g., data used or generated by various application programs of the system.

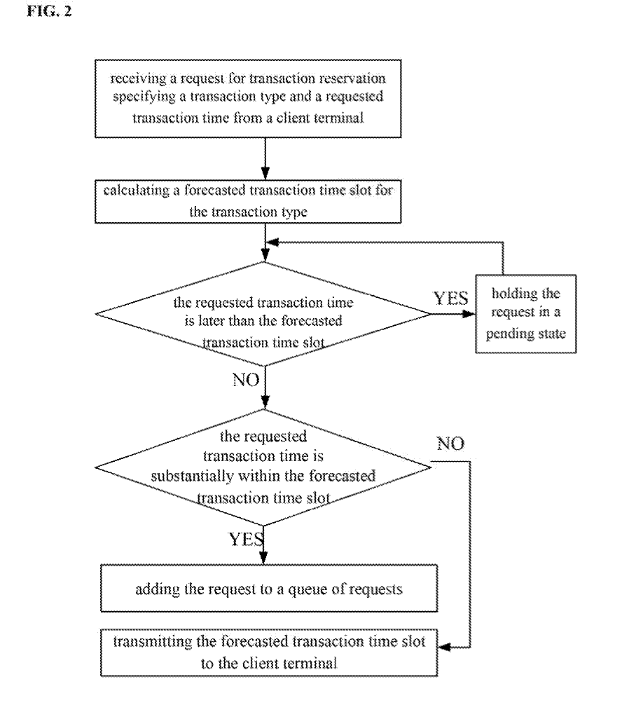

FIG. 2 is a flow chart illustrating a method for accepting transaction reservation in some embodiments according to the present disclosure. Referring to FIG. 2, the method in some embodiments includes receiving a request for transaction reservation specifying a transaction type and a requested transaction time from a client terminal, and calculating a forecasted transaction time slot for the transaction type.

If the requested transaction time is later than the forecasted transaction time slot, the request is held in a pending state. Optionally, the method further includes holding the request in the pending state when the requested transaction time is later than the forecasted transaction time slot; transmitting a signal indicating the pending state to the client terminal; updating the forecasted transaction time slot for the requested transaction type to obtain an updated transaction time slot for the requested transaction type; and adding the request to the queue of requests when the requested transaction time is substantially within the updated transaction time slot.

If the requested transaction time is substantially within the forecasted transaction time slot, the method further includes adding the request to a queue of requests; and transmitting the forecasted transaction time slot to the client terminal. Optionally, the method further includes generating a reservation number based on a position of the request in the queue; and transmitting the reservation number to the client terminal. Optionally, the method further includes updating the forecasted transaction time slot for the requested transaction type to obtain an updated transaction time slot for the requested transaction type; and transmitting the updated transaction time slot to the client terminal.

If the requested transaction time is earlier than the forecasted transaction time slot, the method further includes placing the request in a rejected state; and transmitting a signal to the client terminal indicating the request cannot be fulfilled at the requested transaction time. Optionally, the method further includes transmitting a signal to the client terminal indicating an earliest time slot available for the requested transaction type, suggesting to the user to postpone the transaction time to a later time slot. In one example, the requested transaction time is not within normal working hours, e.g., the forecasted transaction time slot is next earliest available work hour, the request will be rejected, and a signal indicating that the request cannot be fulfilled at the requested transaction time is sent to the client terminal. Upon receiving the signal indicating the earliest time slot available for the requested transaction type, the user may send a new request for transaction reservation specifying a requested transaction type and a new requested transaction time from the client terminal.

In some embodiments, the method further includes receiving from a host terminal real-time information regarding transaction types and transaction durations of ongoing transactions. Optionally, the method further includes transmitting to the host terminal information regarding the queue of requests, including transaction types and positions of the requests in the queue. The host terminal, upon receiving information regarding the queue of requests, will arrange the transactions according to the queue.

In some embodiments, various data may be stored in a virtual memory (e.g., cloud). Examples of data that may be stored in cloud include the request for transaction reservation, the forecasted transaction time slot, the signal indicating the pending state, the reservation number, the updated transaction time slot, the signal to indicating the request cannot be fulfilled at the requested transaction time, the signal indicating an earliest time slot available for the requested transaction type, the real-time information regarding transaction types and transaction durations of ongoing transactions, and the information regarding the queue of requests (e.g., transaction types and positions of the requests in the queue).

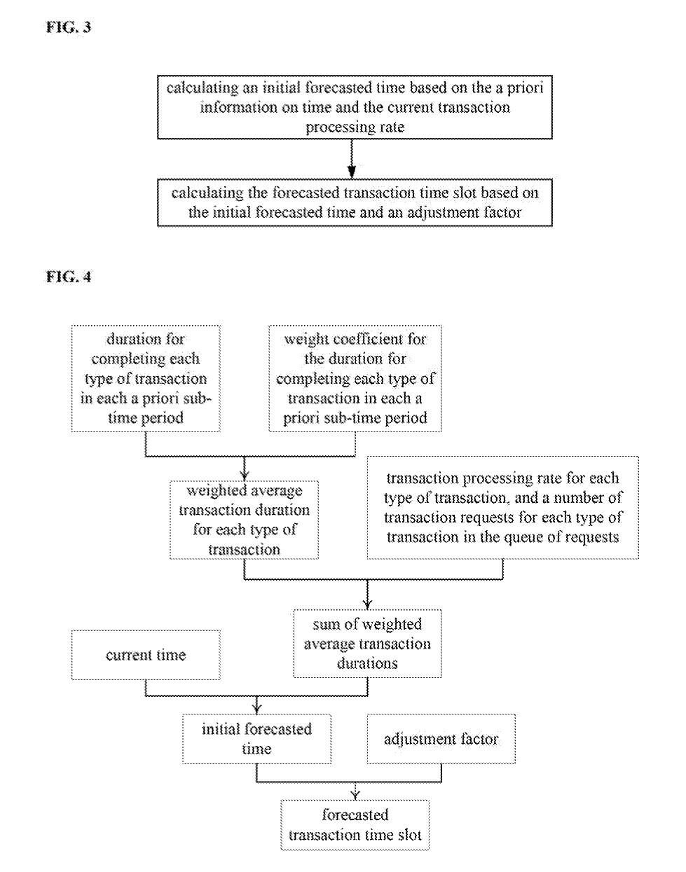

In some embodiments, the forecasted transaction time slot is calculated based on a priori information on time and a transaction processing rate. FIG. 3 is a flow chart illustrating a method of calculating a forecasted time slot in some embodiments according to the present disclosure. Referring to FIG. 3, the step of calculating a forecasted transaction time slot in some embodiments includes calculating an initial forecasted time based on the a priori information on time and the transaction processing rate; and calculating the forecasted transaction time slot based on the initial forecasted time and an adjustment factor.

Optionally, the a priori information on time includes a priori information regarding transaction types and transaction durations in a priori time period. Optionally, the a priori information on time is received from the host terminal. Optionally, the a priori information on time is manually set. Optionally, the a priori information is stored in a virtual memory (e.g., cloud).

In some embodiments, the a priori time period includes a plurality of a priori sub-time periods. Optionally, the a priori time period is selected based on actual needs and may be a certain period of time, e.g., one day, one week, one month, one quarter. Optionally, the a priori sub-time period is selected based on actual needs and may be a certain period of time, e.g., one hour, one day, one week, one month. In one example, the requested transaction is in business sector having a relatively stable transaction flow, e.g., a banking transaction. Optionally, the a priori time period is one month and the a priori sub-time period is one week. In another example, the requested transaction is in business sector in which the transaction flow fluctuates over time, e.g., a restaurant business. Optionally, the a priori information on time includes a first a priori time period corresponding to weekdays and a second a priori time period corresponding to weekends, and the a priori sub-time period is one day. Optionally, the a priori information on time includes seven a priori time periods corresponding to seven days in a week, respectively, and optionally, the a priori sub-time period is one hour.

In some embodiments, transaction processing rate is a ratio between a number of processed transactions and a number of reservations in a certain time period. In one scenario, a client may reserve a transaction but did not show up to complete to the transaction, i.e., the reservation is not taken up as booked. By introducing the transaction processing rate in the process of calculating the forecasted transaction time slot, error introduced by the wasted reservations can be corrected, enhancing the accuracy of forecasting the transaction time slot. Optionally, the transaction processing rate is calculated in a same time period as the a priori time period or the a priori sub-time period. Optionally, the transaction processing rate is calculated in a time period different from the a priori time period or the a priori sub-time period.

FIG. 4 is a flow chart illustrating a method of calculating a forecasted time slot in some embodiments according to the present disclosure. Referring to FIG. 4, the method in some embodiments includes calculating the forecasted transaction time slot based on the initial forecasted time and an adjustment factor. In some embodiments, the initial forecasted time is calculated based on a current time and a sum of weighted average transaction durations. As shown in FIG. 4, the step of calculate the initial forecasted time in some embodiments includes calculating a weighted average transaction duration for each type of transaction in a priori time period; calculating a sum of weighted average transaction durations for a plurality of types of transactions in the queue of requests; and calculating the initial forecasted time based on a current time and the sum of weighted average transaction durations. Optionally, the weighted average transaction duration for each type of transaction is calculated based on a duration for completing each type of transaction in each a priori sub-time period, and a weight coefficient for the duration for completing each type of transaction in each a priori sub-time period. Optionally, the sum of weighted average transaction durations is calculated based on the weighted average transaction duration for each type of transaction, a transaction processing rate for each type of transaction, and a number of transaction requests for each type of transaction in the queue of requests.

In some embodiments, the step of calculating the initial forecasted time includes calculating a weighted average transaction duration t^{T} for a type T transaction in a priori time period according to Equation (1):

$${t}^{T} = {\sum }_{i = 1}^{n} {ω}_{i}^{T} * \overline{{t}_{i}^{T}} ; \qquad ( 1 )$$

wherein the a priori time period includes n a priori sub-time periods, t̅ᵢ̅^̅{̅T̅}̅ is an average duration for completing a type T transaction in the i-th a priori sub-time period, ωᵢ^{T} is a weight coefficient of a duration for completing a type T transaction in the i-th a priori sub-time period.

Optionally, the average duration t̅ᵢ̅^̅{̅T̅}̅ for completing a type T transaction in the i-th a priori sub-time period is calculated according to Equation (2):

$$\overline{{t}_{i}^{T}} = \frac{{\sum }_{j = 1}^{m} {t}_{j}^{T}}{m} ; \qquad ( 2 )$$

wherein m numbers of type T transactions are completed in the i-th a priori sub-time period, 0<i≤n, tⱼ^{T} is a duration for completing the j-th type T transaction in the i-th a priori sub-time period, 0<j≤m.

Optionally, the weight coefficient ωᵢ^{T} is calculated according to Equation (3):

$${ω}_{i}^{T} = \frac{i}{{\sum }_{j = 1}^{n} j} . \qquad ( 3 )$$

In some embodiments, the weight coefficient ωᵢ^{T} in the present disclosure is modeled as a time discrete linear system, providing a dynamic model for forecasting the transaction time slot. In one example, n numbers of a priori sub-time periods are used in the calculation of the initial forecasted time. By having the average transaction duration weighted according to the present method, transaction processing information in relatively recent past periods can be weighted more, and transaction processing information in relatively remote past periods can be weighted less, thereby enhancing the forecast accuracy.

In some embodiments, the step of calculating the initial forecasted time further includes calculating a sum t of weighted average transaction durations for p numbers of types of transactions in the queue of requests according to Equation (4):

$$t = {\sum }_{T = 1}^{p} {r}_{T} {q}_{T} {t}^{T} ; \qquad ( 4 )$$

wherein the queue of requests includes p numbers of types of transactions, the queue of requests includes q_{T} numbers of type T transaction, r_{T} is a transaction processing rate for the type T transaction, 0<r_{T}≤1.

In one example, the queue of requests for a banking transaction includes three clients requesting for opening a new account and two clients requesting for cash withdrawal, i.e., p=2. The transaction processing rate is 0.8 for the new account transaction type and 0.9 for the cash withdrawal transaction type. The weighted average transaction duration t^{T} for the new account transaction type can be calculated to be approximately 10 minutes, and the weighted average transaction duration t^{T} for the cash withdrawal transaction type can be calculated to be approximately 5 minutes. Accordingly, the sum of weighted average transaction durations for five requested transactions in two transactions types can be calculated as: t=0.8×3×10+0.9×2×5=33 minutes.

In some embodiments, the step of calculating the initial forecasted time further includes calculating the initial forecasted time t_{z} according to Equation (5):

t_{z}=t+t₀ (5);

wherein t₀ is a current time.

In some embodiments, the step of calculating the forecasted transaction time slot based on the initial forecasted time and an adjustment factor includes calculating an earliest forecasted time tₘᵢₙ according to Equation (6); and calculating a latest forecasted time tₘₐₓ according to Equation (7):

tₘᵢₙ=g₁t+t₀ (6);

tₘₐₓ=g₂t+t₀ (7);

wherein g₁ is a first adjustment factor, g₁<1, and g₂ is a second adjustment factor, g₂>1.

Additional factors may be considered in calculating the forecasted transaction time slot in combination or in lieu of the adjustment factor discussed herein. In some embodiments, the forecasted transaction time slot is calculated based on the initial forecasted time and an additional factor. In one example, an initial forecasted time is calculated, an earliest forecasted time can be selected at a time earlier than the initial forecasted time, and a latest forecasted time can be selected at a time later than the initial forecasted time. Optionally, the difference between the initial forecasted time and the earliest forecasted time is substantially the same as the difference between the initial forecasted time and the latest forecasted time. In another example, the difference between the initial forecasted time and the earliest forecasted time is 5 minutes, the difference between the initial forecasted time and the latest forecasted time also 5 minutes, the initial forecasted time is 12:00, and the forecasted transaction time slot is 11:55 to 12:05.

In another aspect, the present disclosure provides an apparatus for accepting transaction reservation. In some embodiments, the apparatus includes a communication logic configured to receive a request for transaction reservation specifying a requested transaction type and a requested transaction time from a client terminal; a calculator configured to calculate a forecasted transaction time slot for the requested transaction type; and a processor configured to add the request to a queue of requests when the requested transaction time is substantially within the forecasted transaction time slot. Optionally, the communication logic is configured to transmit the forecasted transaction time slot to the client terminal.

As used herein, the term “logic” refers to hardware (e.g. a board, circuit, chip, etc.), software and/or firmware configured to carry out operations according to the invention. For instance, features of the invention may be accomplished by specific circuits under control of a computer program or program modules stored on a suitable computer-readable medium, where the program modules are configured to control the execution of memory operations using the circuitry of the interface.

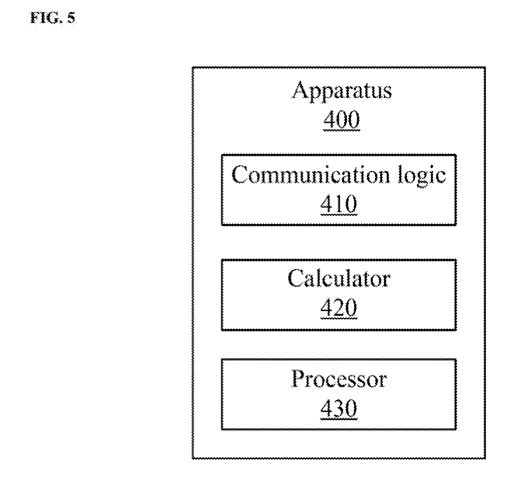

FIG. 5 is a schematic block diagram of an apparatus for accepting transaction reservation in some embodiments according to the present disclosure. Referring to FIG. 5, the apparatus 400 in some embodiments includes a communication logic 410, a calculator 420, and a processor 430. The communication logic 410 is configured to receive a request for transaction reservation specifying a requested transaction type and a requested transaction time from a client terminal, and transmit the forecasted transaction time slot to the client terminal. The calculator 420 is configured to calculate a forecasted transaction time slot for the requested transaction type. The processor 430 is configured to add the request to a queue of requests when the requested transaction time is substantially within the forecasted transaction time slot.

In some embodiments, the processor 430 is configured to generate a reservation number based on a position of the request in the queue. Optionally, the communication logic 410 is configured to transmit the reservation number to the client terminal.

In some embodiments, the calculator 420 is configured to calculate an updated transaction time slot for the requested transaction type. Optionally, the communication logic 410 is configured to transmit the updated transaction time slot to the client terminal.

In some embodiments, the processor 430 is configured to hold the request in a pending state when the requested transaction time is later than the forecasted transaction time slot. Optionally, the communication logic 410 is configured to transmit a signal indicating the pending state to the client terminal. Optionally, the calculator 420 is further configured to calculate an updated transaction time slot for the requested transaction type; and the processor 430 is configured to add the request to the queue of requests when the requested transaction time is substantially within the updated transaction time slot.

In some embodiments, the processor 430 is configured to place the request in a rejected state when the requested transaction time is earlier than the forecasted transaction time slot. Optionally, the communication logic 410 is configured to transmit a signal to the client terminal indicating the request cannot be fulfilled at the requested transaction time. Optionally, the communication logic 410 is further configured to transmit a signal to the client terminal indicating an earliest time slot available for the requested transaction type.

In some embodiments, the processor 430 is configured to place the request in a rejected state when the requested transaction time is not within normal business hours. Optionally, the communication logic 410 is configured to transmit a signal to the client terminal indicating the request cannot be fulfilled at the requested transaction time. Optionally, the communication logic 410 is further configured to transmit a signal to the client terminal indicating an earliest time slot available for the requested transaction type.

In some embodiments, the communication logic 410 is configured to receive real-time information regarding transaction types and transaction durations from the host terminal. Optionally, the communication logic 410 is configured to transmit information regarding the queue of requests to the host terminal.

In some embodiments, the calculator 420 is configured to calculating the forecasted transaction time slot for the requested transaction type based on a priori information on time and a transaction processing rate.

Optionally, the calculator 420 is configured to calculate an initial forecasted time based on the a priori information on time and the transaction processing rate; and calculate the forecasted transaction time slot based on the initial forecasted time and an adjustment factor.

In some embodiments, the calculator 420 is configured to calculate a weighted average transaction duration t^{T} for a type T transaction in a priori time period according to Equations (1) to (3):

$$\begin{matrix}{t}^{T} = {\sum }_{i = 1}^{n} {ω}_{i}^{T} * \overline{{t}_{i}^{T}} ; & ( 1 ) \\ \overline{{t}_{i}^{T}} = \frac{{\sum }_{j = 1}^{m} {t}_{j}^{T}}{m} ; & ( 2 ) \\ {ω}_{i}^{T} = \frac{i}{{\sum }_{j = 1}^{n} j} ; & ( 3 )\end{matrix}$$

wherein the a priori time period includes n a priori sub-time periods, m numbers of type T transactions are completed in the i-th a priori sub-time period, 0<i≤n, t̅ᵢ̅^̅{̅T̅}̅ is an average duration for completing a type T transaction in the i-th a priori sub-time period, tⱼ^{T} is a duration for completing the j-th type T transaction in the i-th a priori sub-time period, 0<j≤m, ωᵢ^{T} is a weight coefficient of a duration for completing a type T transaction in the i-th a priori sub-time period.

Optionally, the calculator 420 is further configured to calculate a sum t of weighted average transaction durations for p numbers of types of transactions in the queue of requests according to Equation (4):

$$t = {\sum }_{T = 1}^{p} {r}_{T} {q}_{T} {t}^{T} ; \qquad ( 4 )$$

wherein the queue of requests includes p numbers of types of transactions, the queue of requests includes q_{T} numbers of type T transaction, r_{T} is a transaction processing rate for the type T transaction, 0<r_{T}≤1.

Optionally, the calculator 420 is further configured to calculate the initial forecasted time t_{z} according to Equation (5):

t_{z}=t+t₀ (5);

wherein t₀ is current time.

In some embodiments, the forecasted transaction time slot is between an earliest forecasted time tₘᵢₙ and a latest forecasted time tₘₐₓ; and the calculator 420 is configured to calculate an earliest forecasted time tₘᵢₙ according to Equation (6); and calculate a latest forecasted time tₘₐₓ according to Equation (7):

tₘᵢₙ=g₁t+t₀ (6);

tₘₐₓ=g₂t+t₀ (7);

wherein g₁ is a first adjustment factor, g₁<1, and g₂ is a second adjustment factor, g₂>1.

In one example, the communication module 410 may be implemented by a program instruction stored in the memory 102 in FIG. 1, executed by the processor 101 in the server 100 in FIG. 1, and performed the steps of transmitting signals and data to the client terminal or the host terminal, and the steps of receiving signals and data from the client terminal or the host terminal.

In another example, the calculator 420 may be implemented by a program instruction stored in the memory 102 in FIG. 1, executed by the processor 101 in the server 100 in FIG. 1, and performed various calculating steps of the present disclosure.

In another example, the processor 430 may be implemented by a program instruction stored in the memory 102 in FIG. 1, executed by the processor 101 in the server 100 in FIG. 1, and performed various processing steps of the present disclosure.

In some embodiments, the present apparatus includes a storage medium for storing one or more program instructions. Various steps of the present method may be performed by executing the program instructions by a computer or processor. Various components (e.g., the communication logic 410, the calculator 420, and the processor 430) may be implemented by executing the program instructions by a computer or processor. Examples of appropriate storage media include, but are not limited to, a memory card of a smart phone, a storage component of a tablet computer, a hard disk of a personal computer, a read-only memory (ROM), an erasable programmable read only memory (EPROM), a compact disk read-only memory (CD-ROM), a USB memory, or any combination thereof.

For example, the current time is 11:00. The client A is planning on conducting a banking transaction at 13:00. The client A may input a request for transaction reservation specifying a requested transaction type A and a requested transaction time (13:00) from a remote client terminal. The server receives the request through a network, and generates a forecasted transaction time slot for the requested transaction type A.

In one example, the reservation number 50 has been taken at the current time, and the number of pending requests in the queue of requests is 30, e.g., 20 clients have already completed their transactions. The forecasted transaction time slot is between 12:56 to 13:06. The client A's request is added to the queue of requests. The client A obtains a reservation number 51. The next reservation number available to a new client (either from a remote client terminal or from an on-site client terminal) would be 52.

In another example, the reservation number 50 has been taken at the current time, and the number of pending requests in the queue of requests is 15, e.g., 35 clients have already completed their transactions. The forecasted transaction time slot is between 12:24 to 12:34. Thus, the requested transaction time, 13:00, is not within the forecasted transaction time slot. Specifically, the requested transaction time is later than the forecasted transaction time slot. The server continues updating the forecasted transaction time slot for the client A's request based on new requests (either on-site or remote) added into the queue of requests, until the client A's requested transaction time (13:00) is within the updated transaction time slot. The client A's request is added to the queue of requests, and the client A obtains a reservation number.

In another example, the forecasted transaction time slot is between 13:44 to 13:54. The requested transaction time, 13:00), is not within the forecasted transaction time slot. Specifically, the requested transaction time is earlier than the forecasted transaction time slot. The server sends a signal to the client A indicating that the request cannot be fulfilled at the requested transaction time (13:00). The client A may request a different transaction time (e.g., after 13:54), or request to be directly added to the queue of requests. If the client A choose to be directly added to the queue of requests, the forecasted transaction time slot would be between 13:44 to 13:54.

In another example, the requested transaction time is not within normal business hours of the bank, e.g., the requested transaction time is an after-hour time. The server sends a signal to the client A indicating that the request cannot be fulfilled at the requested transaction time. The client A may request a different transaction time (e.g., the next day).

In another aspect, the present disclosure provides a client terminal device at the remote client terminal 300A or the on-site client terminal 300B. In some embodiments, the client terminal device is configured to receive an input from a client including a request for transaction reservation specifying a requested transaction type and a requested transaction time, and transmit a signal including the same to the apparatus 400. Optionally, the client terminal device is configured to receive a signal from the server 100 indicating the forecasted transaction time slot, and display the forecasted transaction time slot to the client.

In another aspect, the present disclosure provides a host terminal device at the host terminal 200. In some embodiments, the host terminal device is configured to transmit real-time information regarding transaction types and transaction durations to the server 100, and receive information regarding the queue of requests from the server 100.

In another aspect, the present disclosure provides a system for accepting transaction reservation, including an apparatus described herein, a host terminal apparatus configured to transmit real-time information regarding transaction types and transaction durations, and a client terminal apparatus configured to transmit the requested transaction type and the requested transaction time to the apparatus; and receive the forecasted transaction time slot from the apparatus.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An apparatus for accepting transaction reservation, comprising:
a communication logic configured to receive from a client terminal a request for transaction reservation specifying a requested transaction type and a requested transaction time;
a calculator configured to calculate a forecasted transaction time slot for the requested transaction type; and
a processor configured to add the request to a queue of requests when the requested transaction time is substantially within the forecasted transaction time slot;
wherein the communication logic is configured to transmit the forecasted transaction time slot to the client terminal.

2. The apparatus of claim 1, wherein the processor is configured to generate a reservation number based on a position of the request in the queue; and
the communication logic is configured to transmit the reservation number to the client terminal.

3. The apparatus of claim 1, wherein the calculator is configured to calculate an updated transaction time slot for the requested transaction type at a time interval after the forecasted transaction time slot is calculated; and
the communication logic is configured to transmit the updated transaction time slot to the client terminal.

4. The apparatus of claim 1, wherein the processor is configured to hold the request in a pending state when the requested transaction time is later than the forecasted transaction time slot;
the communication logic is configured to transmit a signal indicating the pending state to the client terminal;
the calculator is further configured to calculate an updated transaction time slot for the requested transaction type; and
the processor is configured to add the request to the queue of requests when the requested transaction time is substantially within the updated transaction time slot.

5. The apparatus of claim 1, wherein the processor is configured to place the request in a rejected state when the requested transaction time is earlier than the forecasted transaction time slot; and
the communication logic is configured to transmit a signal to the client terminal indicating the request cannot be fulfilled at the requested transaction time.

6. The apparatus of claim 5, wherein the communication logic is further configured to transmit a signal to the client terminal indicating an earliest time slot available for the requested transaction type.

7. The apparatus of claim 1, wherein the calculator is configured to calculating the forecasted transaction time slot for the requested transaction type based on a priori information on time and a transaction processing rate.

8. The apparatus of claim 7, wherein the calculator is configured to calculate an initial forecasted time based on the a priori information on time and the transaction processing rate; and calculate the forecasted transaction time slot based on the initial forecasted time and an adjustment factor.

9. The apparatus of claim 8, wherein the calculator is configured to:
calculate a weighted average transaction duration for each type of transaction in the queue of requests in a priori time period;
calculate a sum of weighted average transaction durations for a plurality of types of transactions in the queue of requests; and
calculate the initial forecasted time based on a current time and the sum of weighted average transaction durations;
wherein the priori time period comprises one or more a priori sub-time period;
the weighted average transaction duration for each type of transaction is calculated based on a duration for completing each type of transaction in each a priori sub-time period, and a weight coefficient for the duration for completing each type of transaction in each a priori sub-time period; and
the sum of weighted average transaction durations is calculated based on the weighted average transaction duration for each type of transaction, a transaction processing rate for each type of transaction, and a number of transaction requests for each type of transaction in the queue of requests.

10. The apparatus of claim 8, wherein the calculator is configured to calculate a weighted average transaction duration t^{T} for a type T transaction in a priori time period according to Equations (1) to (3):
$$\begin{matrix}{t}^{T} = {\sum }_{i = 1}^{n} {ω}_{i}^{T} * \overline{{t}_{i}^{T}} ; & ( 1 ) \\ \overline{{t}_{i}^{T}} = \frac{{\sum }_{j = 1}^{m} {t}_{j}^{T}}{m} ; & ( 2 ) \\ {ω}_{i}^{T} = \frac{i}{{\sum }_{j = 1}^{n} j} ; & ( 3 )\end{matrix}$$
wherein the a priori time period includes n a priori sub-time periods, m numbers of type T transactions are completed in the i-th a priori sub-time period, 0<i≤n, tᵢ^{T} is an average duration for completing a type T transaction in the i-th a priori sub-time period, tⱼ^{T} is a duration for completing the j-th type T transaction in the i-th a priori sub-time period, 0<j≤m, ωᵢ^{T} is a weight coefficient of a duration for completing a type T transaction in the i-th a priori sub-time period;
calculate a sum t of weighted average transaction durations for p numbers of types of transactions in the queue of requests according to Equation (4):
$$t = {\sum }_{T = 1}^{p} {r}_{T} {q}_{T} {t}^{T} ; \qquad ( 4 )$$
wherein the queue of requests includes p numbers of types of transactions, the queue of requests includes q_{T} numbers of type T transaction, r_{T} is a transaction processing rate for the type T transaction, 0<r_{T}≤1; and
calculate the initial forecasted time t_{z} according to Equation (5):
t_{z}=t+t₀ (5);
wherein t₀ is a current time.

11. The apparatus of claim 9, wherein the forecasted transaction time slot is between an earliest forecasted time tₘᵢₙ and a latest forecasted time tₘₐₓ;
the calculator is configured to calculate an earliest forecasted time tₘᵢₙ according to Equation (6):
tₘᵢₙ=g₁t+t₀ (6); and
calculate a latest forecasted time tₘₐₓ according to Equation (7):
tₘₐₓ=g₂t+t₀ (7);
wherein g₁ is a first adjustment factor, g₁<1, and g₂ is a second adjustment factor, g₂>1.

12. A system for accepting transaction reservation, comprising:
an apparatus of claim 1;
a host terminal apparatus configured to transmit real-time information regarding transaction types and transaction durations; and
a client terminal apparatus configured to transmit the requested transaction type and the requested transaction time to the apparatus; and receive the forecasted transaction time slot from the apparatus.

13. A method for accepting transaction reservation, the method being performed by one or more processors of a server, and comprising:
receiving from a client terminal a request for transaction reservation specifying a requested transaction type and a requested transaction time;
calculating a forecasted transaction time slot for the requested transaction type;
adding the request to a queue of requests when the requested transaction time is substantially within the forecasted transaction time slot; and
transmitting the forecasted transaction time slot to the client terminal.

14. The method of claim 13, further comprising:
generating a reservation number based on a position of the request in the queue; and
transmitting the reservation number to the client terminal.

15. The method of claim 13, further comprising:
updating the forecasted transaction time slot for the requested transaction type to obtain an updated transaction time slot for the requested transaction type; and
transmitting the updated transaction time slot to the client terminal.

16. The method of claim 13, further comprising:
holding the request in a pending state when the requested transaction time is later than the forecasted transaction time slot;
transmitting a signal indicating the pending state to the client terminal;
updating the forecasted transaction time slot for the requested transaction type to obtain an updated transaction time slot for the requested transaction type; and
adding the request to the queue of requests when the requested transaction time is substantially within the updated transaction time slot.

17. The method of claim 13, further comprising:
placing the request in a rejected state when the requested transaction time is earlier than the forecasted transaction time slot; and
transmitting a signal to the client terminal indicating the request cannot be fulfilled at the requested transaction time.

18. The method of claim 13, wherein the forecasted transaction time slot is calculated based on a priori information on time and a transaction processing rate.

19. The method of claim 18, wherein calculating a forecasted transaction time slot comprises:
calculating an initial forecasted time based on the a priori information on time and the transaction processing rate; and
calculating the forecasted transaction time slot based on the initial forecasted time and an adjustment factor.

20. The method of claim 19, wherein calculating the initial forecasted time comprises:
calculating a weighted average transaction duration for each type of transaction in the queue of requests in a priori time period;
calculating a sum of weighted average transaction durations for a plurality of types of transactions in the queue of requests; and
calculating the initial forecasted time based on a current time and the sum of weighted average transaction durations;
wherein the priori time period comprises one or more a priori sub-time period;
the weighted average transaction duration for each type of transaction is calculated based on a duration for completing each type of transaction in each a priori sub-time period, and a weight coefficient for the duration for completing each type of transaction in each a priori sub-time period; and
the sum of weighted average transaction durations is calculated based on the weighted average transaction duration for each type of transaction, a transaction processing rate for each type of transaction, and a number of transaction requests for each type of transaction in the queue of requests.

21. (canceled)

22. (canceled)
